(19) United States
(12) Patent Application Publication
(10) Pub. No.: US 2017/0155269 A1
(43) Pub. Date: Jun. 1, 2017

(54) ARMAMENT WITH WIRELESS CHARGING APPARATUS AND METHODOLOGY

(71) Applicant: Joseph A. Swift, Dolgeville, NY (US)

(72) Inventor: Joseph A. Swift, Dolgeville, NY (US)

(21) Appl. No.: 14/955,642

(22) Filed: Dec. 1, 2015

(51) Int. Cl. H02J 7/02; H02J 50/40; H02J 50/12

(52) U.S. Cl. CPC H02J 7/025; H02J 50/12; H02J 50/40

(57) ABSTRACT

Disclosed herein is an integrated system armament capable of receiving an inductive charge, the integrated system armament comprising at least one induction energy receiving unit and at least one electrical conductor; wherein the at least one electrical conductor is of an advanced composite material with the advanced composite material having an electrical power management region, an electrical power management sub-region, an advanced composite material forming an electrical power management micro domain, or combinations thereof; and further wherein at least one of the advanced composite material forming electrical conductor(s) further comprises a thermal power management component having a thermal power management region, a thermal power management sub-region, a thermal power management micro domain, or combinations thereof; which in combination provides the integrated system armament. Further disclosed is a method of wirelessly charging an integrated system armament capable of receiving an inductive charge.

### CROSS-REFERENCE TO RELATED APPLICATIONS

This application claims priority to U.S. Provisional Patent Application Ser. No. 62/085,919 filed Dec. 1, 2014, the contents of which are incorporated by reference herein as if set forth in their entirety for all purposes as if put forth in full below.

### STATEMENT REGARDING FEDERALLY SPONSORED RESEARCH OR DEVELOPMENT

None

### THE NAMES OF THE PARTIES TO A JOINT RESEARCH AGREEMENT

None

### BACKGROUND OF THE INVENTION

Armaments include arms, defensive equipment, offensive equipment, weapons, guns, munitions, ordnance, explosives, missiles, torpedoes, shells, bombs, grenades, firearms, pistols, rifles, revolvers, shotguns, grenade launchers, rocket launchers, projectile-firing systems, projectile-propelling systems, weapons-firing systems, rockets, vehicles, land vehicles, ships, aircrafts, spacecraft, and any combinations of the above. Armaments may also include items for which a military, police, or sports-persons are equipped, including: helmets, shields, back packs, body armor, and the like. Specific examples of common rifles, shotguns, and small weapons include but are not limited to: AR-15, M-16 and M-5 types, Remington® 870, Beretta® 92, Colt® 1911 and Glock® 17 styles and the like. Specific examples of common large weapons include but are not limited to: strategic and tactical missiles, and large projectile-firing systems such as Intercontinental Ballistic Missiles (ICBMs), aircraft as well as other vehicle-launched missiles, land and ship-launched missiles and rockets, personnel shoulder-launched missiles and rockets, smart bombs, laser guided bombs, and any related motion-capable large explosive apparatus using internal or remote electrical power.

Frequently these armaments are equipped with internally and/or externally attached, affixed, embedded, integral with, mounted, or connected accessories such as electric devices, electronic devices, sensors, controllers, navigation aids, navigation lights, communication devices, radar defeating signal transmitters, illumination sources, solid or fluid fueled engines, heating elements, power sources, batteries, fuel cells, solar cells, and the like, as well as antennae, RFID tags, and the like.

Sometimes these accessories are a mounting rail or rack s or some other accessory connection device. Such devices may be an integrated system armament that allows multiple other accessories to be added to the armament, which serves to enhance the functionality of the armament and thereby make it more versatile.

Accessories can be of conventional and standardized design but are often non-standardized and/or of a propriety design, originating from numerous commercial sources or they can be customized to a particular armament. The accessories may also be affixed to the armament, often requiring an intermediary attachment mechanism to serve as an interface between the accessory and the armament. Often identical versions of a base armament are modified for special operations, missions, military and law enforcement departments or end user.

These accessories frequently use electrical power in one or more forms and frequently have a variety of sizes, shapes, power requirements, battery types, heat generation levels, operating specifications and failure modes. These accessories may contain their own power source and these power sources usually come in the form of batteries, battery banks, solar panels, piezoelectric generators, and/or power storing capacitors or super capacitors. These power sources regardless of where they are located, within or on the accessory or within or on the armament, are often unreliable and take up a major amount of space and are generally a source of considerable weight to the armament and/or accessories. Furthermore, these power sources may be prone to damage or intermittent failure and generally require frequent replacement and special care and maintenance.

Most batteries used for these accessories are disposable and not rechargeable, even though their indiscriminant disposal can represent an environmental hazard, as well as a safety or tactical hazard. However, rechargeable power sources are becoming increasingly popular for electronics and electronic devices; such as computers, navigation devices, and communication devices. The frequent need to replace or repair power sources also creates waste, and requires armament bearers to carry rather large batteries and/or replacement batteries. The additional batteries add to the weight carried by the armament bearer. There is also a need to store or dispose of the used batteries creating a situation where the armament bearer must carry used batteries or leave the batteries in the field of operations causing a potential environmental hazard, safety and tactical hazard.

The result of the above identified attributes for many armaments is an assortment of armament varieties and models having a variety of accessories, attaching mechanisms, and power sources which, upon integration with the armament, create a complex, poorly performing, and heavy and/or bulky armament system. As armament users' demand increases for more and more complex accessories, the number of accessories mounted to or on the armament increases and the number of mechanisms for attachment to their armaments increases while the demand for power and power sources also increases. The weight of these accessories makes the armament heavy and affects the balance of the armaments, affecting the armament's cost, accuracy, reliability, and performance.

The solution to these problems is to have an apparatus where the armament and/or accessory has on or within it a means for wirelessly transmitting and/or receiving electromagnetic energy, to which a power storage device, and/or an accessory can be connected and powered. Fewer and smaller batteries will be needed. The wireless power providing and optionally power controlling mechanism can be distributed through the armament components or connected directly to the accessory to minimally affect the weight and balance of the armament. This will significantly make the armament lighter and shrink the cost, size, and weight of the attached accessories.

Patent application Ser. No. 13/999,054 filed Jan. 8, 2014, the contents of which are incorporated by reference herein as if set forth in their entirety for all purposes as if put forth in full below, generically discloses apparatus having management of electrical power capacity regions and management of thermal capacity regions.

Patent application Ser. No. 14/447,822 filed Jul. 31, 2014, the contents of which are incorporated by reference herein as if set forth in their entirety for all purposes as if put forth in full below, generically discloses composite interconnect accessory rail system.

The publication; Military Standard: Dimensioning of Accessory Mounting Rail for Small Arms Weapons, AMSC, 3 Feb. 1995; establishes standard methods of dimensioning accessory mounting rails for small arms weapon systems. It also establishes uniform accessory mounting rails and requirements that are interchangeable among the different units of the U.S. Defense Department.

Thus, it is clear that an armament wireless charging apparatus as well as the materials and processes with which they are made must be reconsidered in an effort to meet the still known, but unmet needs as well as those that will emerge well into the future.

Disclosed herein in certain preferred embodiments is a wirelessly charging apparatus: comprising an integrated system armament, with at least one induction energy receiving unit, at least one electrical conductor, and at least one power using device.

### BRIEF DESCRIPTION OF THE DRAWINGS

FIG. 1 is a prior art armament illustrating an assembly comprising, multiple components and accessories.

FIG. 2 is an exemplary induction member comprising, a pair of coils configured into an apparatus that is capable of wireless, non-contact inductive charge transfer.

FIG. 3 depicts an assembly of induction charging circuit members to comprise one aspect of the present invention.

FIG. 4 illustrates an arrangement of a plurality of induction coils capable of serving as an inductive charge receiving member integrated into an electromagnetically responsive grid comprised of multiple induction responsive units and a multiplicity of electrical conduits.

FIG. 5A is an illustration of an integrated system armament comprising, an induction charge receiving unit of the present invention.

FIG. 5B is an illustration of an integrated system armament comprising, an induction charge transfer system of the present invention.

FIG. 6A is a graphical representation of example data illustrating performance of an assembly of induction loops.

FIG. 6B is a graphical representation of example data illustrating performance of an assembly of induction loops having various materials within the coil interspacing region.

FIG. 7 is a graphical representation of example data illustrating performance of an assembly of induction loops having a fabric-like reinforcement layer within the coil interspacing region.

FIG. 8 depicts a cross-sectional view of an induction member configured into a multilayer advanced composite of the present invention providing an electrical conduit and a thermal conduit.

FIG. 9 is an illustration of a large integrated system armament comprising an induction charge receiving unit of the present invention.

### DETAILED DESCRIPTION

Before explaining some embodiments of the present invention in detail, it is to be understood that the invention is not limited in its application to the details of any particular embodiment shown or discussed herein since the invention comprises still further embodiments, as described by the granted claims.

Unless otherwise clearly specified the terminology used herein is for the purpose of description and not of limitation. Further, although certain methods are described with reference to certain steps that are presented herein in a certain order, in many instances, these steps may be performed in any order as may be appreciated by one skilled in the art, and the methods are not limited to the particular arrangement of steps disclosed herein.

As utilized herein, the following terms and expressions will be understood as follows:

The term “about” as utilized herein refers to the statistically average variability as is typically found in the art of the invention herein.

The expression “accessibly embedded contact surface” refers to a substrate, region, sub-region, or micro-domain of an electrically and/or thermally conductive material encased within a second material to enable contact to be made between at least a portion of the embedded electrical and/or thermal conductor, i.e., the interconnect, and an external contact substrate to complete an electrical and/or thermal circuit.

The term “accessory” refers to an electrically and/or thermally functional device capable of connecting directly or indirectly to an armament; where such device utilizes or produces an electrical current, either directly or involving a power source; or such device utilizes or produces thermal energy, either directly or involving a thermal source; or such device may itself be an armament. For example, such devices include but are not limited to: a sight, a scope, an aiming accessory, an enhancement to an existing aiming accessory, a display, a flashlight, an infrared light, a black box IR source, an illumination accessory of any adapted wavelength(s) in the spectrum, a laser, a Taser or other or conducted electrical weapon is an electroshock weapon, a night-vision apparatus, a communications accessory, a sensor, a rechargeable battery, or combinations thereof.

The expression “accessory attachment device” refers to an accessory which is mounted, affixed, connected to, or attached to an armament for the purpose of mounting, affixing, connecting, or attaching at least one additional accessory to the armament.

The term “advanced” refers to a system or material that due to its composition, design, or use is at, or performs at, a level that is above a generally accepted norm or base of comparison. In some instances it refers to a higher level of complexity when compared to common or contemporary systems, materials, methods, or ideas.

The expression “advanced armaments systems” means any armament or projectile propelling apparatus comprising, consisting of, and consisting essentially of at least one advanced composite material.

The expression “advanced composite” means a material capable of replacing metals and created by combining at least one reinforcement filler with a compatible host system. The advanced composite may be in any form, e.g., a rigid solid, a semi-rigid solid or a flexible solid, an elastomer, a prepreg, and the like.

The expression “advanced composite material” refers to a composition of matter comprised of a matrix material and at least one fibrous filler material. Typically, the fibrous filler works in concert with the matrix to provide or contribute to a critical property of the composite. Examples of such critical properties include high strength, high stiffness, and high modulus of elasticity, electrical conductivity, thermal conductivity, and low specific density when compared to other common materials. Examples of matrix materials may include: polymers, ceramics, glasses, cements, metals as well as blends and combinations thereof. Examples of fibrous filler materials include: carbon fiber(s), carbon nanotubes, fiberglass, metal fibers, fine metal filaments, polymeric fibers including fine polymeric fibers, mineral fibers, basalt fibers, metalized carbon fibers, metalized carbon nanotubes, metalized glass, metalized basalt, metalized mineral fibers, natural fibers, metalized natural fibers, composite fibers, and mixtures and combinations thereof. The fibrous filler materials may include: solid fibers, hollow fibers, bi component fibers, multicomponent fibers, single or multilayered fibers and may be of any size, shape, or geometric configuration, and may have any surface topography and may be rigid, semi rigid, flexible, elastic, or porous and combinations thereof.

The expression “advanced composite structure” means a physical member comprised of at least one advanced composite material.

The term “armament” as utilized herein includes arms, defensive equipment, offensive equipment, weapons, guns, munitions, ordnance, explosives, missiles, torpedoes, shells, bombs, grenades, firearms, pistols, rifles, revolvers, shotguns, grenade launchers, rocket launchers, projectile-firing systems, projectile-propelling systems, weapons-firing systems, rockets, vehicles, land vehicles, ships, aircrafts, spacecraft, and any combinations of the above. An armament may also be an accessory to another armament. Armaments may also include items for which a military, police, or sports-persons are equipped, including: helmets, shields, back packs, body armor, and the like. Specific examples of common rifles, shotguns, and small weapons include but are not limited to: AR-15, M-16 and M-5 types, Remington® 870, Beretta® 92, Colt® 1911 and Glock® 17 styles and the like. Specific examples of common large weapons include but are not limited to: strategic and tactical missiles, and large projectile-firing systems such as Intercontinental Ballistic Missiles (ICBMs), aircraft as well as other vehicle-launched missiles, land and ship-launched missiles and rockets, personnel shoulder-launched missiles and rockets, smart bombs, laser guided bombs, and any related motion-capable large explosive apparatus using internal or remote electrical power.

The expression “armament component” refers to any of the parts which comprise an armament. For example, on small arms, this may refer to but is not limited to: butt stocks, grips, or barrels.

The expression “composite contact” refers to one-half of a contact pair consisting of an electrically or thermally conductive surface that may be electrically or thermally connected to at least one second composite contact to form a circuit to permit flow of electrical and/or thermal energy.

The term “controller” as utilized herein is an object capable of receiving and/or transmitting electrical and/or thermal energies and shall mean a circuit member capable of at least one of; sensing, measuring, or modulating an electrical and/or thermal energy.

The expression “critical property” refers to at least one physical, mechanical, electrical, thermal, or optical property of a composite that enables the advanced composite material to provide the desired functionality when used in a specific application.

The expression “electrical conductor” means a wire, cable, or similar object capable of conducting an electrical current.

The expression “electrical contact” refers to one-half of a contact pair consisting of an electrically conductive surface that may be electrically connected to at least one second electrical contact to form a circuit to permit flow of electrical current.

The expression “electrical conduit” refers to a pathway in, through and/or around a conductive material that is capable of conveying current or transporting electrical or electrostatic charge.

The expressions “electrical interconnect” or “electrical interconnection,” refers to physical contact or near contact between two or more electrical conduits enabling passage of current or transport of charge(s). In certain instances, it refers to the interface substrate between two, or more electrical conduits.

The expression “electrical power management” shall be understood to be a characteristic of the advanced composite material where the advanced composite material has regions for electrical conduction and regions for electrical insulation and where electrical power transmission can be controlled using the electrical conduction and insulation properties of the advanced composite material.

The expression “electrically functional” refers to an action, activity, and/or an outcome of, or, effect provided by an electrical component, such as a resistor, capacitor, inductor, transformer, diode, integrated circuit, display, sensor, power source, and the like, that when combined with at least one other electrical substrate and/or electronic member creates an electric circuit wherein at least one characteristic of the circuit is influenced or affected by the operation of the subject component in the energized circuit.

The expression “electrically insulating” means an electrically resistive material having a high effective electrical resistance, for example having a d.c. volume resistivity in the range greater than about 10⁶ ohm-m and having a capability to prevent the flow of current in one, or more parts of the circuit or between adjacent circuits.

The expression “electro mechanical structure (EMS)” means a combination or assembly of two or more substrates, regions, sub-regions, or micro-domains into a unit having a capability to support a load in the form of a mechanical stress, or strain, vibration, or impact without deleterious effect to the structure and the capability to convey a current or transport charge.

The expression “electro-thermo-mechanical structure (ETMS)” means a combination or assembly of two or more substrates, regions, sub-regions, or micro-domains, or features into a unit having a capability to support a load in the form of a mechanical stress, strain, vibration, or impact without deleterious effect to the unit and its capability to perform an electric/electronic and/or thermal energy function.

The term “fluid-tight” as applied to a contact(s) refers to an interconnection between two contacts wherein provision is made in a contact assembly region to exclude fluids, e.g., water, sea water, air, and other gases or other airborne or fluid borne contaminants from entering or exiting the contact region. Provision means; e.g., the rubber seals, sealants, greases, over-coatings, tight fitting joints, secondary enclosures, and the like; are capable of providing fluid tight seals. In some instances herein, “fluid tight” may refer to the capability of an apparatus or housing to exclude fluids.

The terms “induction” or “inductive” when used in conjunction within an expression shall be understood to encompass both magnetic induction and magnetic resonance.

The expression and term “induction coil” or “coil’ shall refer to a conductive material which is wound one or more times or otherwise shaped, molded, printed, electroformed, plated, or configured to form a spiral, a generally circular pattern, or similar form. Typically the coil will have at least two contact regions generally located at the coil end regions where connection to an electrical circuit can be made to enable power to be provided to a power using accessory. In order to achieve a high desired level of wireless inductive charging performance the material may be wound at least two times around a suitable core material, wherein the core is made of any suitable solid, liquid, gaseous, or intermediate material.

The expression “induction coil preform” refers to a composite member consisting of one or more wire loops or composite wire loops that are formed into a coil configuration wherein a thin surface layer of an electrically insulating coating is applied upon the surface of the wire. The induction coil preform is formed into a rigid or semi-ridged solid by use of the polymer coating layer(s) on the base wire as an inter-winding and/or inter-layer binder, or by use of a secondary adhesive to thereby create a durable, solid member. This member, when solidified, cured, or partially cured, crosslinked, or partially crosslinked is referred to as a preform and is capable of withstanding subsequent handling and processing operations that enable it to be integrated with an encasing composite and related encasement process.

The expressions “induction grid” or “grid” shall refer to conductive material which is configured in a 2-dimension or 3-dimension geometric pattern where the material has at least two terminal ends of the conductive material capable of providing electrical contact to an electric circuit. The grid may be fabricated into a sheet or other geometric form by any suitable process such as hand lay-up, casting, knitting, weaving, braiding, and the like. The term “grid”, when referred to as “integrated grid”, refers to an assembly of coils and/or loops that are configured into a network where power transfer can occur at one, or more, positions across or within the network.

The expression and term “induction loop” or “loop” shall refer to conductive material which is formed in a general pattern having any geometric shape, such as a generally circular pattern, an elongated oval, a square-shape, a rectangular shape, a triangular shape and the like.

The expression “induction member” shall refer to an induction coil, induction loop, induction grid, or combinations thereof and any structure which responds to an electromagnetically induced energy.

The expression “induction energy receiving unit” shall refer to a receiver circuit comprising, consisting of, and consisting essentially of an induction member, a power management controller and a thermal management controller.

The expression “induction transfer unit” refers to a pairing of at least one power or signal receiving member and at least one power or signal transmitting member wherein the power or signal is transferred there-between via wireless means.

The term “integrated” refers to a structural system which is organized so that constituent units function cooperatively.

The expression “integrated system” refers to an apparatus wherein the component parts, either on or within a structural feature are organized so that the parts are capable of functioning cooperatively.

The expression “integrated structural system” means two or more structural members combined into a unit. In preferred embodiments, the combination of two or more advanced composites creates an enhancement to, or synergy between one or more critical properties, such as mechanical strength, impact resistance, vibration tolerance, and the like.

The term “interconnected” refers to establishment of a connection between two or more regions, sub-regions or micro domains forming a circuit wherein electric or thermal energy may flow between the regions sub-regions or micro domains, or combinations thereof.

The expression “managing electrical energy” means the control of movement, removal, storage, or regulation of electrical energy.

The expression “managing thermal energy” means the control of movement, removal, storage or regulation of thermal energy.

The expression “micro domain” refers to any segment or several segments of a region or sub-region that has a distinct structure and a distinct function.

The term “polymer” includes, but is not limited to any organic molecule or large molecule made up of chains or rings of linked monomer units including, but not limited to: polyurethane, nylon, polyester, polyimide, epoxy, silicone, fluoropolymers, as well as copolymers, blends and mixtures thereof.

The term “rack (not shown)” means a frame, housing, or framework, typically with regions, bars, hooks, straps, or pegs, for holding or storing things.

The term “rail” means a structural member such as a bar or series of bars, optionally fixed on one, or more supports, serving to hang things on.

The term “reinforcing” refers to the effect of one material when combined with at least one second material that results in strengthening, fortification, and/or improvement of at least one characteristic of the material or the combination of materials.

The term “region” as utilized herein is the functional portion of the advanced systems armament with a defined separate response to the functional requirements and/or stimulus.

The expression “structural component” means a feature having a capability to support a load in the form of a mechanical stress or strain without deleterious effect to the feature.

The expressions “structural member” means a physical unit having a capability to support a load in the form of a mechanical stress or strain without deleterious effect to the unit.

The expressions “structural substrate” means a physical substrate unit having a capability to support a load in the form of a mechanical stress or strain without deleterious effect to the substrate unit.

The term “substrate” refers to a base layer or a layer that is underneath a subsequent layer. It can also refer to a surface onto which a second material such as a coating, a finish, a paint, a catalyst, a metal layer, insulating layer, or combinations thereof which is applied.

The expression “thermal conductor” refers to any material that conveys or conducts heat.

The expression “thermal conduits” refers to a pathway in, through, and/or around a conductive material that is capable of conveying or transporting heat

The term “thermal contact” refers to one-half of a contact pair consisting of an electrically or thermally conductive surface that may be thermally connected to at least one second thermal contact to form a circuit to permit flow of electrical and/or thermal energy.

The expressions “thermal interconnect” and “thermal interconnection” refer to the physical contact or near contact between two, or more thermal conduits that enables passage of heat. In certain instances, they refer to the interface region between two, or more thermal conduits.

The expression “thermal power management” shall be understood to be a characteristic of the advanced composite material where the advanced composite material has regions for thermal conduction and regions for thermal insulation and where thermal energy transmission can be controlled using the thermal conduction and insulation properties of the advanced composite material.

The expression “thermo-electric management” shall be understood to be a characteristic of the advanced composite material where the advanced composite material has regions for both electrical and thermal conduction and regions for both electrical and thermal insulation and where both electrical and thermal energy transmission can be controlled using the electro-thermal conduction and insulation properties of the advanced composite material.

The present invention may be an integrated system armament capable of receiving an inductive charge, the integrated system armament comprising at least one induction energy receiving unit and at least one electrical conductor; wherein the at least one electrical conductor is of an advanced composite material with the advanced composite material having an electrical power management region, an electrical power management sub-region, an advanced composite material forming an electrical power management micro domain, or combinations thereof; and further wherein at least one of the advanced composite material forming electrical conductor(s) further comprises a thermal power management component having a thermal power management region, a thermal power management sub-region, a thermal power management micro domain, or combinations thereof; which in combination provides the integrated system armament.

The integrated system armament may further have a housing for the induction energy receiving unit comprising an advanced composite material.

The integrated system armament may further have at least one accessory.

The integrated system armament may further have the at least one induction energy receiving unit affixed or integral to the integrated system armament wherein the induction energy receiving unit is affixed or integral to an armament component, affixed or integral within an armament component, affixed or integral to an accessory, affixed or integral within an accessory or combinations thereof.

The integrated system armament may further have the induction energy receiving unit comprising at least one induction member comprising of an advanced composite material.

The integrated system armament may further have at least one accessibly embedded contact surface.

The integrated system armament may further have the at least one induction member in an orientation that is planar to an external surface, non-planar to an external surface, or combinations thereof.

The integrated system armament may further have at least one power storage device residing within the integrated system armament.

The integrated system armament may further have the at least one accessory comprising an advanced composite material and where the at least one accessory is a rail, a rack (not shown), an accessory attachment device or combinations thereof.

The integrated system armament may further be fluid tight.

The integrated system armament may further comprise an advanced composite structure.

In yet a further embodiment of the invention provides a method of wirelessly charging an integrated system armament capable of receiving an inductive charge, the method comprising: providing at least one integrated system armament capable of receiving an inductive charge, providing a source of inductive power; bringing the integrated system armament capable of receiving an inductive charge and the source of inductive power into proximity with each other such that the inductive power flows from the source of inductive power to the integrated system armament capable of receiving an inductive charge; providing at least one conduit for movement of electrical energy for the integrated system armament, providing at least one conduit for movement of electrical energy within the integrated system armament, providing at least one location for restriction of movement of electrical energy within the integrated system armament selected from the group consisting of a sub-region and micro domain, providing at least one conduit for movement of electrical energy for at least one accessory, providing at least one conduit for movement of thermal energy for the integrated system armament, providing at least one conduit for movement of thermal energy for the at least one accessory, and providing at least one location for restriction of movement of thermal energy within the integrated system armament selected from the group consisting of a sub-region and micro domain.

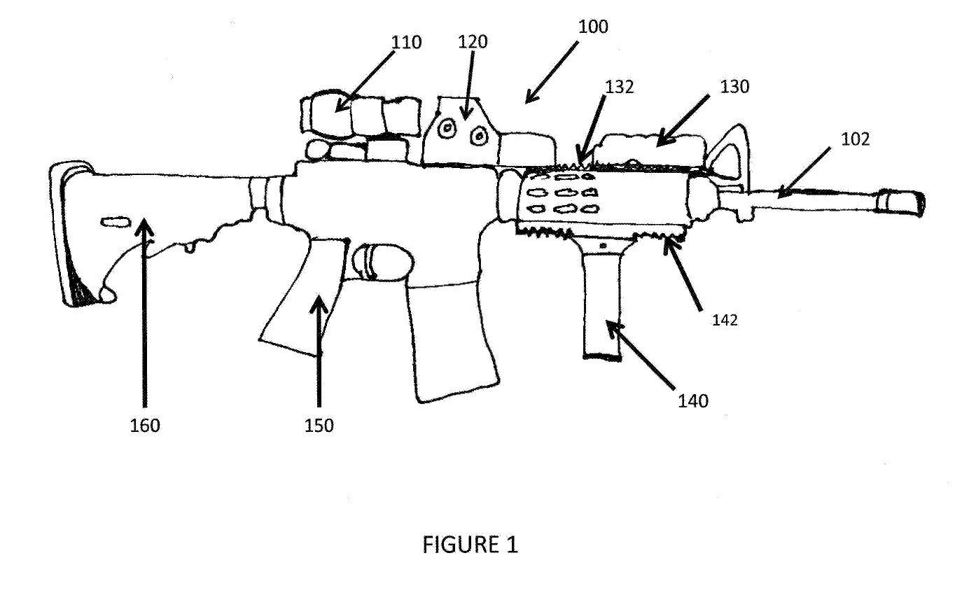

The invention herein will be better understood by reference to the figures wherein like reference numbers refer to like components. FIG. 1 illustrates a prior art armament system comprised of an armament member (100) comprising a multiplicity of functional components, such as a butt stock (160), pistol grip (150), barrel and receiver member (102), fore end shroud containing a rail-type accessory mount (142), and an upper accessory rail-type mount (132) where onto the various rail regions are shown mounted various power consuming accessories; comprising a powered primary optic (110), a powered secondary optic (120), a powered laser designator (130), and a multifunctional fore end vertical grip (140) with integrated power source (370).

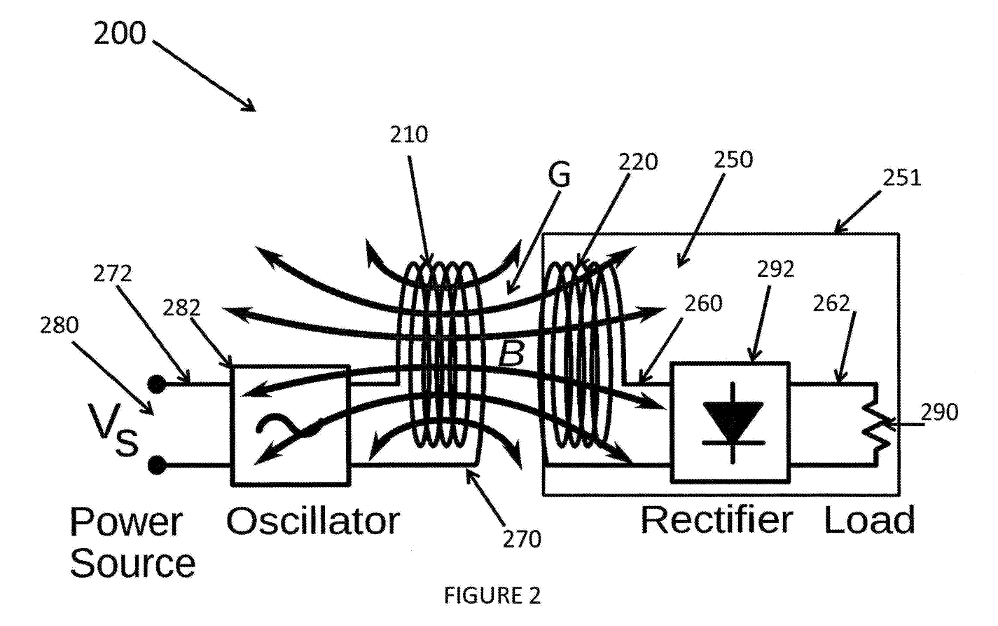

FIG. 2 is an exemplary induction apparatus (200) that is capable of wireless, non-contact inductive charge transfer. A set of induction charge transfer generally circular coil members (210, 220) is illustrated in the configuration of a pairing of two coils comprised of thin wire or wire-like constituents, such as that of copper, copper coated carbon fiber, nickel, aluminum, metal coated carbon fiber, copper or aluminum or nickel coated fiberglass or other suitable substrate fiber, or as multiplicity of filaments or fibers such as stainless steel filaments, copper strands, and the like, configured as a pair of generally circular coil members (210, 220) and associated circuitry (282, 292) and interconnecting conductive leads (260, 270) where direct electrical connection can be made at the terminal ends (272, 262). The generally circular coil members (210, 220), each with their own circuitry, serve cooperatively to transfer electrical power across a gap (G) without direct contact between the generally circular coil members (210, 220) or any interconnecting electrical connection by the action of a mutual electromagnetic field (B) that is created upon the flow of electrical energy (i.e. input power) provided by a power source (280). A power sensing, regulating, and controlling member (not shown), together with optionally a temperature sensing member (not shown) having appropriate control and/or logic circuitry (not shown) is represented collectively as an oscillator form of associated circuitry (282) in FIG. 2. The power source (280) and oscillator combine to provide and regulate the input power (Vs). The leftmost coil assembly of the generally circular coil members (210) serves as a wireless power transmitting source to the inductive power-transfer circuit while the rightmost coil assembly of the generally circular coil members (220) serves as the energy receiving member to which a power requiring load (290) and associated circuitry (292) and associated interconnecting conductive leads (260) may be attached at the terminal ends (262). The receiving assembly comprises at least one inductive generally circular coil members (220) that receives the energy provided across the gap (G) by the transmitting unit and may have associated circuit control members, such as a rectifier (292) in series with the load member (290) wherein a means is provided for conductive interconnects (260) to serve as the conduits for energy to flow from the generally circular coil members (220) to the controller (292) and there through a second interconnection (262) to the load (290).

The generally circular coil members (210, 220) are formed from any suitable material that can create and/or respond to an electromagnetic field (B) produced upon power delivery from the power source (280) to the transmitting coil of the generally circular coil members (210). One or both of the generally circular coil members (210, 220) may be formed from a single loop or from any number of overlapping or under lapping or side lapping loops in a generally spiral configuration to form the induction coils of the generally circular coil members (210, 220). In general, the greater the number of loops that are wound to create the coils and the finer (i.e. thinner) the filaments that are used in the generally circular coil members (210, 220), the more efficiently the paring will perform.

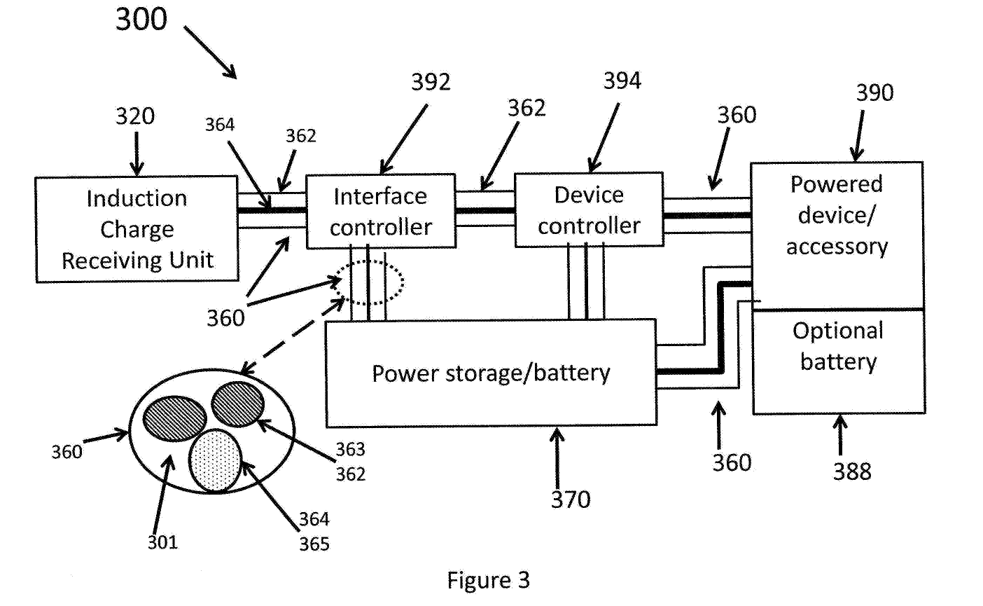

FIG. 3 is a detailed illustration of the assembly (300) of the receiving portion of the induction apparatus (200) comprised of at least one coil member induction energy receiving unit (320) connected to provide wireless power transfer from a transmitting unit of the generally circular coil members (210) to a power storage battery or other power source (370) internal to the apparatus or to an accessory integrated power source (388), a power using device (390), or both or any combination thereof. Power moves through one or more suitable conducting conduits (360) from the induction energy receiving induction energy receiving unit (320) to an interface controller (392) which may serve to regulate, modify, or direct power flow to a rechargeable battery or other rechargeable power source (370), or to a device controller unit (394) to provide power to one, or more power using device (390) or accessories. Conductive conduits (360) comprise at least one electrical conducting conduit (362) or electrical conductor (363) and optionally at least one thermal conductor (364) integrated into a conduit capable of transporting electric, signal, and/or thermal energy. The at least one electrical conducting conduits (362) or electrical conductor (363), or at least one thermal conductor (365) may be encased in a suitable enveloping member (301). Additional conducting conduits (360) may provide interconnects between and amongst the various elements comprising, consisting of, and consisting essentially of the inventive apparatus. The conducting conduits (360) may be identical or different in size, shape, configuration, and make up and may be of any suitable material, size, and form and may be configured from fine conductive elements, fibers, or wires, or combinations thereof to fulfill the circuit requirements for interconnecting conductors. A temperature sensor may be provided within the interface controller (392) and/or within the device controller unit (394) or the power using device (390) and any combination thereof to monitor and respond to thermal variations that may be necessary to assure and maximize operational performance of the assembly (300). Optionally, the interface controller (392) and the device controller (394) may be combined into a single, integrated unit. Optionally, temperature sensing and controlling members may be distributed at any location within or upon the assembly (300). The interconnecting conduits may comprise any size, shape, and composition. The conduits (360) comprise at least one electrically conductive conductor (363) and may comprise at least one thermally conductive member (364) which either thereof may, optionally be encased in a suitable enveloping member (301).

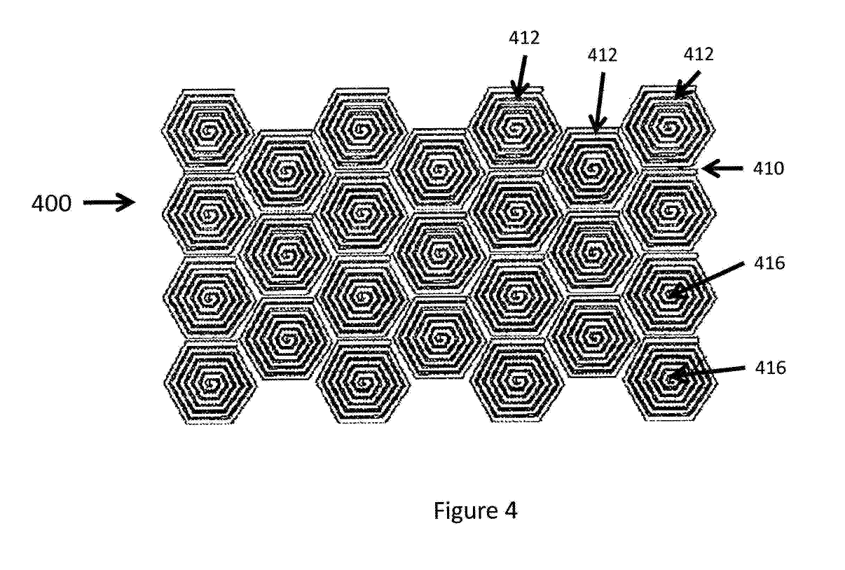

FIG. 4 illustrates a multiple induction grid or network (400) wherein a plurality of induction coils (412) are co-formed and interconnected in series to form an induction receiving grid (410) for movement of electrical energy. The multiplicity of individual induction coils (412) are interconnected electrically in series through direct contacting conduits formed between adjacent loops and onto and through a circuit board collector substrate region (not shown) hidden beneath the induction receiving grid (410) whereon the points of contacts to the collector (not shown) originate and terminate at the central points (416) of the individual loops thus providing for wireless transfer of higher power levels between a similarly configured transmitting unit (not shown) and the induction receiving grid (410).

Any suitable number of the generally circular coil members (220) may be combined into an induction receiving grid (410) by use of suitable conducting linkages and serve as a highly efficient receiving generally circular coil members (220) of the inductive charge transfer apparatus (200). Any number of generally circular coil members (220) can be combined to form the induction receiving grid (400) where the individual induction coils (412) may be interconnected in the manner of, preferably a series electrical circuit, or in some instances in a parallel electrical circuit or in combinations of series and parallel electric circuits. The combination of induction coils (412) to create an induction receiving grid (400) allows for wireless energy transfer over a greater area, higher levels of energy transfer, and provides a means for compensation of potential misalignment of the generally circular coil members (210, 220).

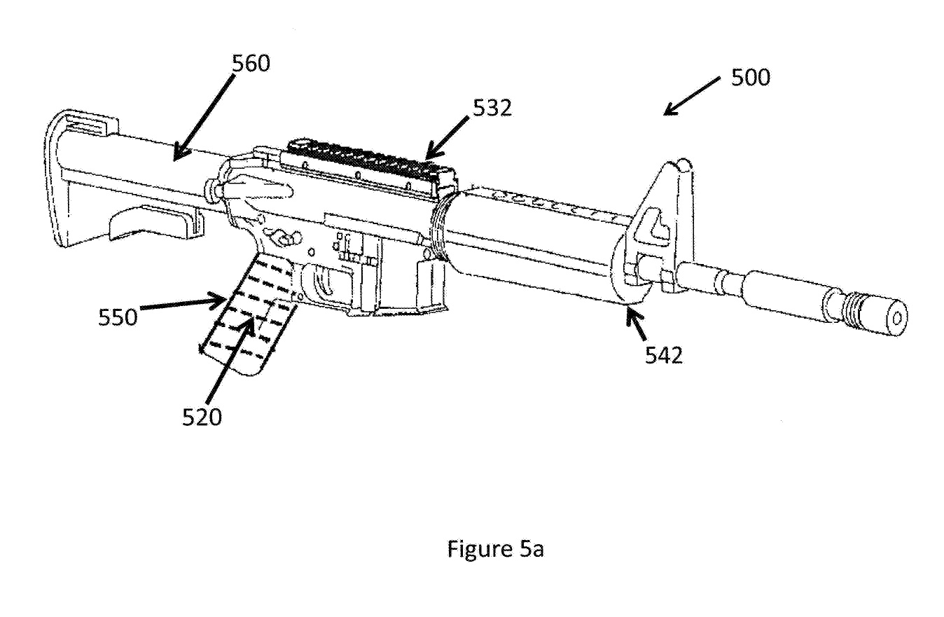

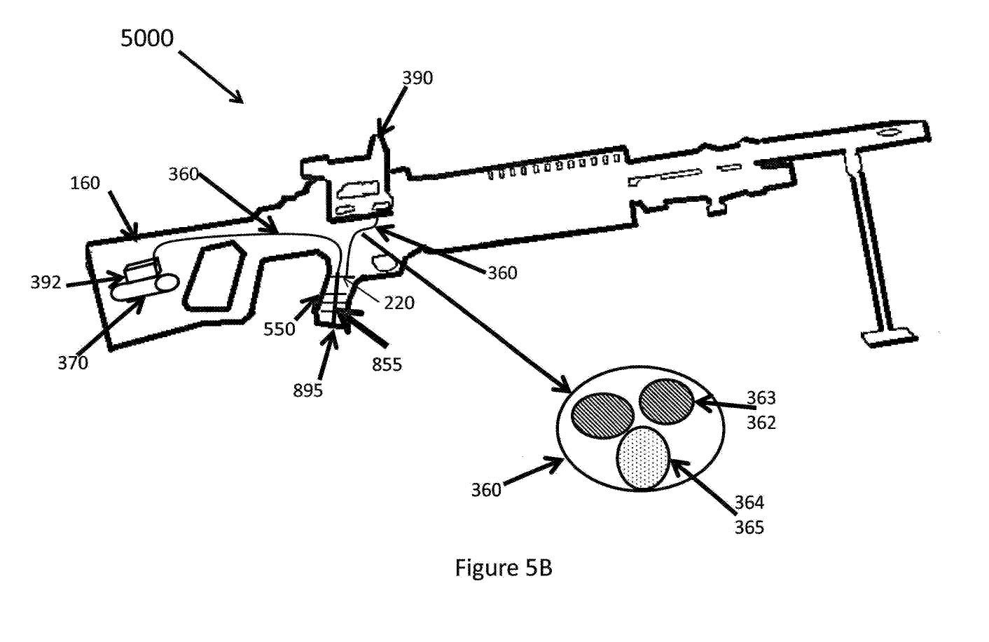

FIG. 5A illustrates an integrated system armament (500) comprised of at least one induction receiving member (520) of the present invention integrated within a grip (550) of an AR type small firearm to form the integrated system armament (500). The grip (550) may be formed from a suitable polymer or thermal plastic material which serves as host matrix and encasement layer (851) to a multiplicity of fine conductive filaments of the induction receiving member (520) wrapped in a loop configuration thereby creating an advanced composite of the present invention. The grip (550) serves in a primary role to function as a hand hold for the firearm's user to carry and operate the AR type small firearm form of the integrated system armament (500). At least a portion of the grip (550) is used to wirelessly receive and to provide power to at least one of: an interface controller (392), a device controller (394), a power source (370), a power using accessory (390), an accessory battery (388), or combinations thereof when it is brought into nearby association with a suitable inductive power transmitting generally circular coil members (210). Any number and configuration of induction receiving member (520) may be integrated into any suitable armament member or multiplicity of members, such as the butt stock (560), the fore end shroud (142, 542), a fore end grip (140), and the like and into a plurality of locations within each as may be required to provide means to accommodate all of the power needs of the integrated apparatus.

In FIG. 5A, an accessory attachment device (532) is depicted in the form of a rail.

FIG. 5B depicts a preferred embodiment of the present invention (5000) wherein an induction receiving member (220) is integrated into an advanced composite to create the advanced composite structure having the form of a grip member (550) of an AR type armament. Encased within the grip (550) is an inductive receiving generally circular coil members (220) integrated near to, but just below, the outermost surface of the grip (550). The generally circular coil member (220) is configured to take on the external shape of the grip (550) and resides at a location slightly below the outermost surface of the grip (550).

Integrated with the induction receiving generally circular coil members (220) is a thermal conductive sub-region (855) that serves as a conduit to conduct thermal energy from the heat generating receiving generally circular coil members (220) and convey the thermal energy to an outermost region of the grip (895) where heat can be transferred to the surrounding environment. Integrated within the armament is an internal power source (370) such as a rechargeable device or battery along with an interface controller (392), a device controller (394) or a combination thereof. Further integrated within the armament is at least one conduit (360) comprising interconnecting electrical conduits (362) and/or optionally thermal conduits (364) that move power between the induction receiving unit (220) and at least an interface controller (392), a device controller (394), a power storage unit (370) and a powered accessory device (390). A thermal conduit (364) may serve to move thermal energy within the conduit (360).

In operation, an inductive transmitting unit (220) is configured into a generally circular form within the grip wherein the grip member (550) has dimensions selected to allow, generally non-contacting insertion into and interaction with the transmitting coil region (210) of a transmitting base member.

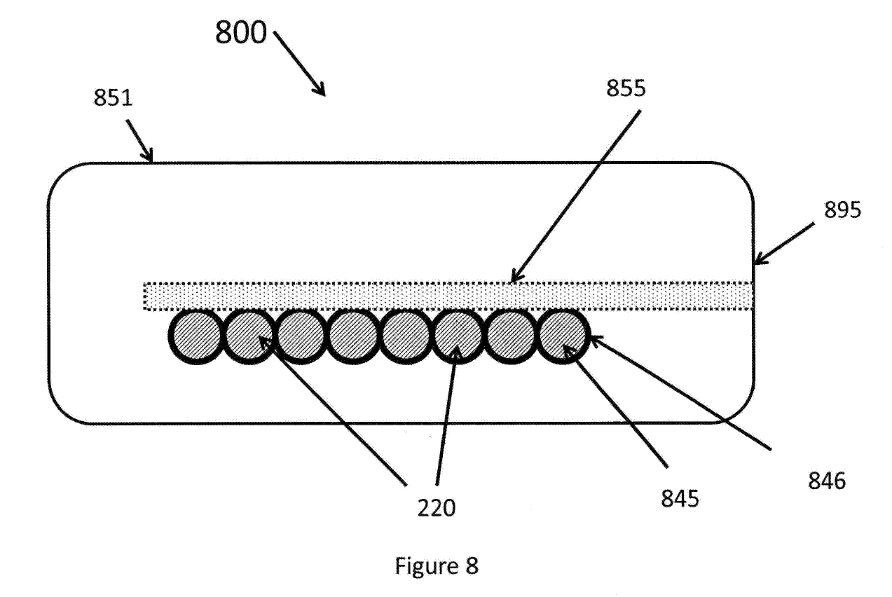

FIG. 8 depicts a preferred embodiment of the present invention wherein an advanced composite structure (800) is illustrated in a cross-sectional view. The advanced composite structure (800) comprises: an induction charge energy transfer receiving coil sub-region that is depicted as a cross cut of a plurality of induction generally circular coil members (220), a thermally conductive sub-region (855) and an enveloping advanced composite sub-region (851). The generally circular coil members (220) serve as an inductive energy receiving member as well as an electrical conduit for movement of electric energy as well as optionally as a thermal conduit. The generally circular coil members (220) may further comprise at least two micro domains consisting of an electrically conductive, electromagnetically responsive core members (845) onto which a suitable electrical insulating layer (846) is applied. The generally circular coil members (220) may comprise any suitable electrically conductive member that is electromagnetically responsive, such as; fine metal wire, for example copper, aluminum, iron, a layer-configured metal-on substrate filament such as, for example, a copper coated carbon fiber, an aluminum coated glass fiber, and the like, and an electro-conducting, electromagnetic responsive advanced composite, for example, a fine metal particle filled polymer, or combinations thereof. The electromagnetically responsive core members (845) has a thin, thermally conductive, electrically insulating layer, also referred to as a second micro-domain (846) applied thereto, and upon at least a portion of the coil sub region a thermally conductive layer (855) is affixed. An encasement region (851) is employed to contain the constituent sub-regions and micro domains and thereby create one embodiment of the advanced composite structure of the present invention. The thermally conductive layer (855) may extend onto or close to an outermost surface of the structure (895) to thereby provide a conduit for heat and means of convective heat exchange with the external environment.

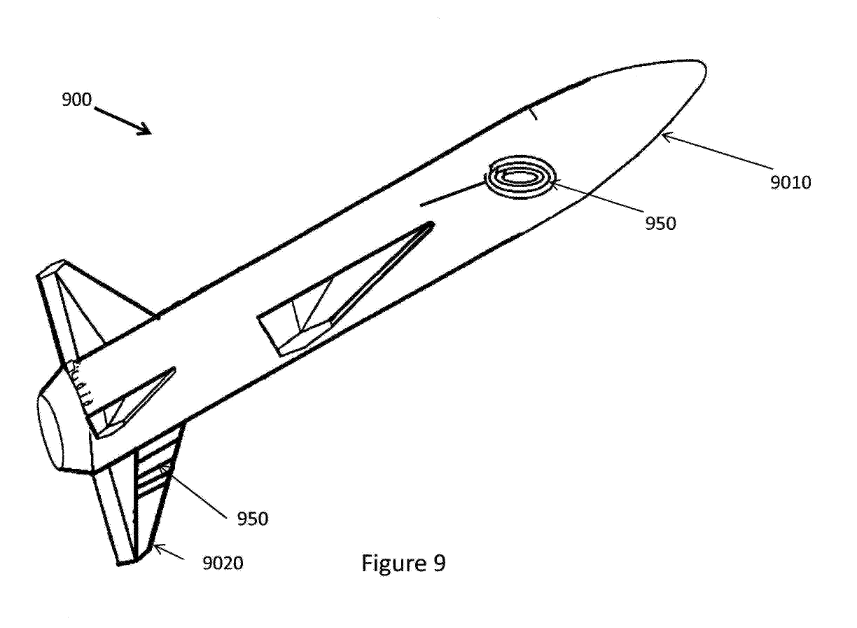

FIG. 9 is an illustration of a large integrated system armament (900) comprising, an assembly of induction charging circuit members (950) as depicted in FIG. 3 of the present invention. The assembly of induction charging circuit members (950) is integrated within or upon the external shell of a missile type armament. The assembly of induction charging circuit members (950) comprises at least one of; an induction power receiving unit (250), an interconnecting conduit (360), an interface controller (392), a device controller (394), a power storage unit (370) and a power utilizing device (390). The assembly of induction charging circuit members (950) may be positioned at any suitable location on the missile apparatus, for example in a forward region (9010) or in a rearward region for example within or upon an external projecting feature such as a fin (9020). The integrated system armament (900) may comprise more than one assembly of induction charging circuit members (950) that may be located at various positions close to where power may be required, reducing the mass and length of connecting conduits (360) as well as the overall weight of the armament. Further, the assembly of induction charging circuit members (950) may be positioned at any suitable location on the missile apparatus where it may be accessible to a source of inductive wireless power from a transmitting member (210).

A battery or other power storage device may be part of the multi-component, integrated system armament (500). Accessory attachment devices (532) and battery form of the power source (370) or other power storage devices are themselves, accessories (390). Accessory attachment devices (532) such as, rails (532), and rack (not shown), are capable of attaching to or connecting to other accessories (390). The electrical conductors (363), thermal conductors (364), induction members (220), armament components (such the vertical grip (550), the butt stock (560), and the fore end shroud (542), or accessories (390) or combinations thereof may be made from an advanced composite material and may comprise an advanced composite structure (800).

An armament is composed of many parts. The induction energy receiving unit (320) may be affixed to or integrated within the armament, an armament component (550) or combination thereof in such a manner so that placing the armament on or within or by connection to a wireless power transmitting base, the induction energy receiving unit (320) will become a power source (370) for the integrated system armament (500) and armament accessories (390).

Many accessories (390) require a power source (370), often in the form of a power storage device. This power source (370) may be a rechargeable power source internal to the accessory (388) or the accessory (390) may be able to connect to an external power source (370). If an external power source (370) is required, the external power source (370) may be in the form of an induction energy receiving unit (320), connected via an electrical conductor (362) to the accessory (390); or the accessory (390) may be connected to a power source (370) via an electrical conductor (362); or the accessory (390) may be connected to another accessory (532), usually an accessory attachment device accessory (532), a rail (532), or a rack (not shown), and where the accessory attachment device (532), rail (532), or rack (not shown) is/are connected to a power source (370). The connection (not shown) to the power source (370) is either direct or through an electrical conductor, and where the power source (370) may be a power storage device or an induction energy receiving unit (320). If an internal power source (not shown) is required for the accessory (532), an induction energy receiving unit (520) may be directly connected to the accessory in order to supply power to the accessory's internal power source (not shown).

A non-limiting example comprises, at least one region of an advanced composite structure armament (500) of the present invention configured to have at least one electrically insulating region (wherein the electrically insulating region employs at least one film forming polymer having a high d.c. volume resistivity, for example greater than about 1×10⁶ ohm-m, and having a high dielectric breakdown strength, for example greater than about 12.7×10³ V/m that is applied as a durable, heat resistant, thermally conductive, thin layer to the surface of a selected length of fine wire or wire-based composite. The thickness of the layer can range from about a few monomolecular layers (viz. in the range of 1-1000 nm) to about a millimeter or more depending upon the application requirements.

The thermal and electrical conductivities of an advanced composite comprising at least one filler and one polymer are dependent upon many factors. Conductive filler, such as carbon fiber, may range from about <5% to about >50% loading, by weight. At the low end of the concentration range, the addition of carbon filler has little or no effect upon the thermal conductivity of the resultant composition, and it acts as a thermally insulating filler while serving to increase the mechanical strength of the composite. As carbon fiber loading in the advanced composite is increased it transcends a region from insulating to conductive wherein the level of conductivity is relatively loading independent. Loading of between about 20% by weight and about 50% by weight are selected to achieve in-plane thermal conductivities in the range of about 2 to about 30 W/(m*K) which are preferred in order to assure reliable conductivity results from various processing methods. Various mixtures of carbon fiber and polymer may be combined with the coil preform to regulate ETMS thermal and electrical properties.

A non-limiting example may use a commercially available metal coil, loop, or grid within a host polymer to form an integrated structure such as a vertical fore-grip for an AR-15. Solidifying a metal induction member within a host polymer can enable the member to be affixed or made integral to any type of armament or armament component to form an integrated structure.

The induction member may be made wholly from an advanced composite material where the advanced composite material comprises: at least one carbon fiber filled region, sub-region, substrate, or micro domain and in contact with at least one metalized region, sub-region, substrate, or micro domain. Depending upon filler loading, such an advanced composite would enable at least one of; an electrically conductive or electrically insulative regions, sub-regions, substrates, or micro-domains; thermally conductive or insulative regions, sub-regions, substrates, or micro domains; or electro thermally conductive or insulative regions, sub-regions, substrates, or micro domains. The advantage to such a structure comprising said advanced composite would allow for electrical power management and thermal power management within the induction member material limiting the need for additional power and thermal management circuitry; bulky thermal conductors connected to the induction member or induction energy receiving unit.

A further benefit to creating an induction member from an advanced composite material would be that the power management controller can be programmed to accept a greater range of makes or models of charging bases or a greater variety of charging configurations since the heat management properties of the advanced composite material can dissipate thermal energy from the induction member via a thermal conduction properties to an area or areas away from the circuitry or to an area where thermal energy may be beneficial. In cold weather, channeling thermal energy from an area of heat buildup to an area of need will benefit both the armament user and the operation of the armament and allow for better balancing of hot and cold armament areas.

Furthermore, the circuitry enclosed in the induction energy receiving unit housing may be protected from heat buildup due to inefficient charging, or less-than ideal configurations, or non-ideal charging bases by creating induction energy receiving unit housing from an advanced composite material. As a non-limiting example, housing designed from an advanced composite material may provide thermal conduction to an area outside the induction controller, while providing thermal insulation to the rest of the circuitry from the heated area and providing thermal insulation at all regions, sub-regions, substrates, or micro-domains outside the region, sub-regions, substrates, or micro-domains being used to channel thermal energy.

### Examples

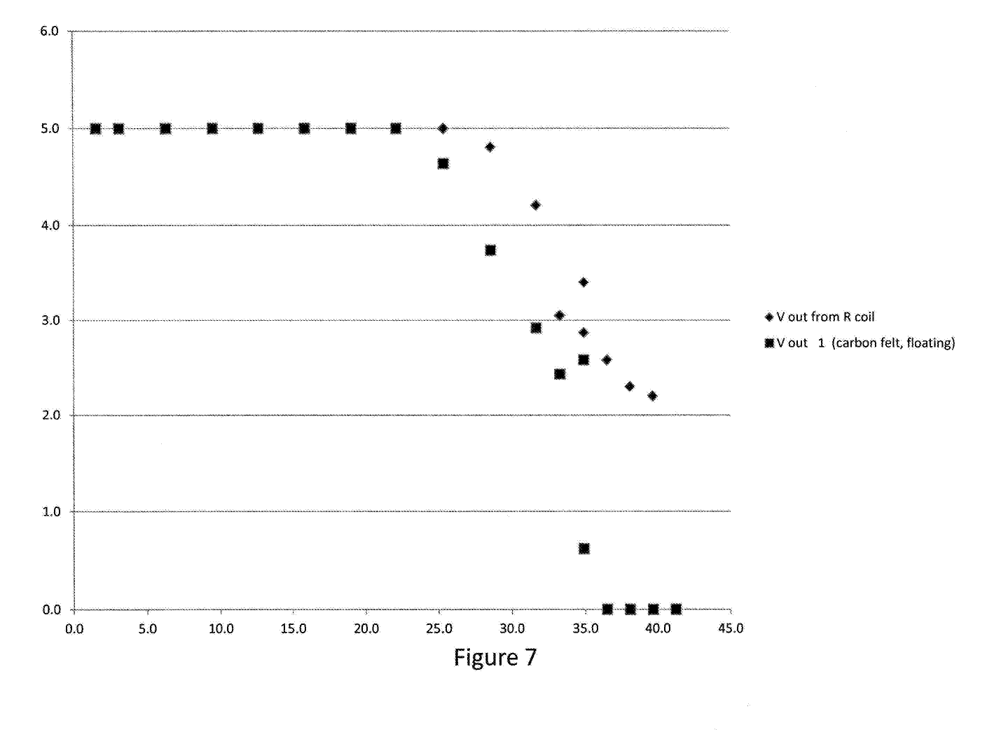

For all of the examples described herein, the output voltage parameter is considered to be a reliable surrogate for inductor coil pair performance. FIG. 7 illustrates the dependency of the output voltage of the receiver coil (220) when a carbon fiber felt specimen that has been designed to serve as an advanced composite reinforcement material is positioned within the inter-coil gap (G). The graph in FIG. 7 includes data from a baseline example (i.e. with no reinforcement material) to permit direct comparison to results obtained with the carbon felt in the inter-coil separation gap. The comparison reveals only minor downward shifts in the operational spacing range (OSR) and critical spacing (CS) characteristics. Since the operational spacing range remains high, i.e. in the range of about >90%, it is concluded that sheet forms of carbon felts do not significantly affect the overall charge transfer performance. Depending upon the type and fill density of carbon fiber along its orientation in the felt, the in-plane thermal conductivity (viz. along the major, length-wise direction of the fibers) of carbon fiber based felts can fall within the range of about 1.0 to about 25 W/(m*K), or greater while the thru-plane (viz. perpendicular to major direction) conductivities may fall within the range of about 0.5 to about 5.0 W/(m*K), or greater. Thus, carbon felt configurations are viewed to be attractive materials and forms to serve as thermal and electrical property-modifying and/or property-controlling additives in the advanced composites of the present invention.

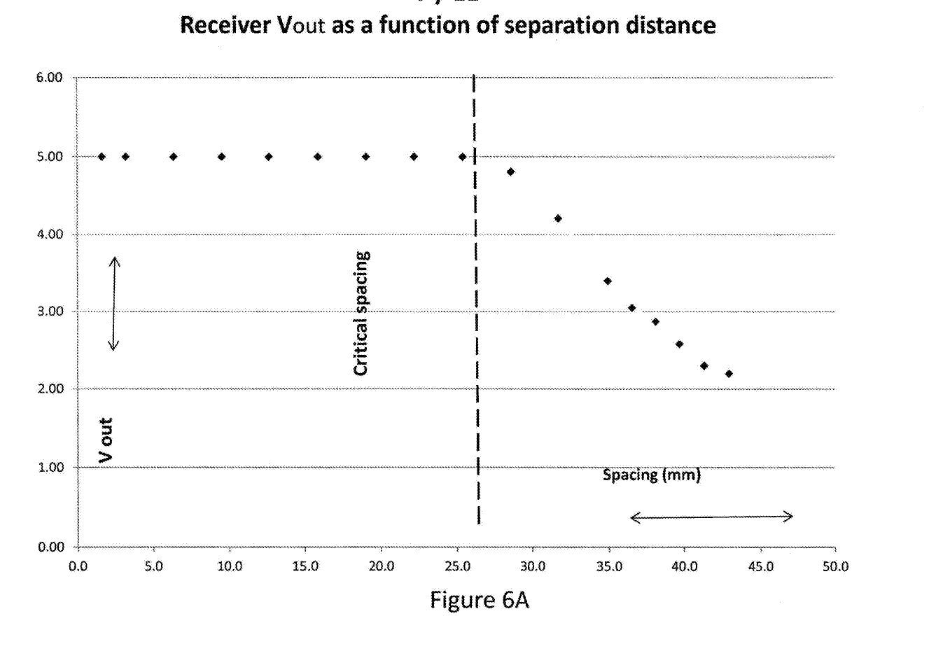

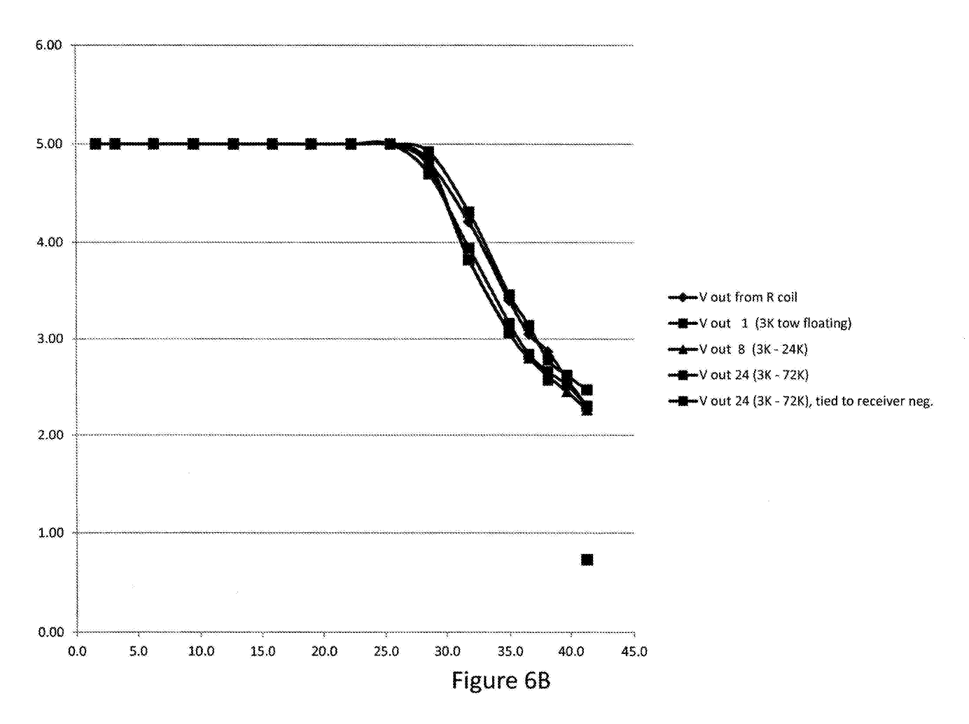

FIG. 6A is a graphical representation illustrating the behavior of the receiving coil member (220) as the spacing distance (G) from the transmitting coil (210) was increased by insertion of plastic spacing members having a constant thickness of 1.5 mm to step-wise establish and control the gap (G) separating the coil members. In the example, an input voltage of 12 V was applied to the transmitting coil (210) and was held constant throughout the example series. The output voltage of the receiving coil was processed through a control/measurement circuit and the d.c. output voltage (Vₒᵤₜ) was recorded as the inter-coil spacing was increased over a range from 0 mm to about 50 mm. The results reveal a rather large range of coil separation (G) over which the output voltage is constant. This region is followed by a second region of rapid drop in output voltage as the spacing increases. The region of inflection is narrow (viz. <2-3 mm) and thus enables quantification of an important behavioral characteristic associated with this particular pair of induction coils, which herein is referred to as the “critical spacing”. The example results suggest that as few as two parameters can represent the performance of these and other induction charge transfer coil pairs under non-contacting conditions. The first is referred to herein as the “operational spacing range” (OSR) and the second is referred to as the “critical spacing” (CS). For the above identified coil pair, the measured OSR spanned a range of 0 to 25 mm (OSR=0-25 mm) and the CS occurred at a spacing of 25.5 mm (CS=25.5 mm).

A second set of examples was designed and related experiments were conducted to probe into the effects upon charge transfer performance of the above-identified coil pair when a variety of materials was sequentially inserted into the inter-coil gap (G). For these examples, one of the gap-controlling spacers functioned also as rigid mounting surface for each of the candidate reinforcement materials under evaluation. Initial candidates were chosen targeting certain combinations of high thermal and electrical conductivity. The materials included a commercially available 3,000 filament carbon fiber tow (viz. 3k, C-F tow) that was evaluated at four different gap filling densities. Thermal conductivities fell within in the range of about 20 to about 200 W/(m*K) and electrical conductivity within the range of about 10 to about 0.1 S/m

A thin layer over coating was applied onto each of the carbon fiber tows used to create a thin, high electrical resistance surface layer that was needed to prevent inter-fiber shorting and shorting between fibers when inserted into the intercoil gap (G). In the first example of this series, one tow comprising 3,000 individual filaments in the form of a continuous strand was cut into a length of 75 mm. Before cutting, a short length of electric tape was applied to a narrow region (circa. 6 mm) at each end of the strand to secure the strand into a durable unit capable of withstanding subsequent handling operations and to maintain a close alignment of the fibers throughout the test. The strand length was chosen in order to assure that it spanned the entire width of the coils' diameter (38 mm) and to extend a significant distance beyond thereby assuring its inter-coil position within the entire range of coil separation gaps. In two follow-on examples, a longer length of 3K overcoated tow was configured into wrapped plies resulting in a greater fill density of filaments within the inter-coil gap as well as creating a larger cross section of conductive mass capable of greater heat transfer. During this phase of the tests, the strands were allowed to float without electrical bias while in the separation gaps. The specimens were thusly designated (see FIG. 6B) as “floating” since these received no external bias. For the final example of this series, the largest (viz. the 72,000 filament strand) was connected to the negative terminal of the receiver coil and thereby providing an electrical reference to the strand.

FIG. 6B indicates results from four examples presented in a single graphic view. Illustrated is the finding that when compared to the result where no filler material was present in the coil separation gap (FIG. 6A), we observe from FIG. 6B no significant difference in the overall performance. From this data, it is concluded that these candidate and similar filler materials may be employed as non-interacting, reinforcing fillers in the advanced composites of the present invention.

Carbon-fiber tows as well as a wide range of other conducting fibrous materials may be configured into a variety of other forms such as continuous carbon fiber filled felts and fabrics, and, chopped fiber filled felts and fabrics. In general, fabrics are manufactured by a weaving or knitting process while felts are non-woven textiles that are made by matting, condensing and pressing fibers together and secured by a binder resin. Many complex configurations and materials combinations are possible where each has the capability of delivering unique performance characteristics, including even greater thermal heat transfer behaviors when combined with various polymers to thusly create the type of novel advanced composites of the present invention. In this light, further examples were designed and conducted to probe into the effect, if any, that a thermally conductive, carbon fiber-based felt or fabric may have upon coil performance.

A set of custom felt fabrics were fabricated by combining short lengths of chopped carbon fiber with various organic polymers to create a set of liquid phase filler-binder mixtures. A hand lay-up technique was used to spread each of the mixtures evenly into individual drying trays wherein the mixtures were allowed to set and to dry fully. A series of carbon fiber rich, felt-like specimens of about 0.3 m×about 0.3 m having thickness in the range of 3 to 6 mm were fabricated. Each specimen was observed to be sufficiently porous to permit fluid flow in the cross sectional direction and thusly, optionally under vacuum, to facilitate interpenetration of a selected, second polymer or polymer composite during a later manufacturing stage where the felt may serve as a reinforcement layer of a more complex, advanced composite member.

FIG. 6A is a graphical representation of example data depicting the behavior of a receiving coil member (220) configured into an inductive charge transfer system (200) as the spacing distance (G) from the transmitting coil (210) was increased. The findings indicate that a high level of performance may be achieved over a range of gaps (G) that range from 0 to about 25 mm even when non-conductive plastic spacers are interpositioned in the gap.

FIG. 6B is a graphical representation of example data representing the behavior of a receiving coil member (220) configured into an inductive charge transfer system (200) as the spacing distance from the transmitting coil was increased and various conductive materials in the form of continuous fibers were inserted into the gap (G). The findings indicate that a high level of performance may be achieved over a range of gaps (G) that range from 0 to about 25 mm even when a variety of carbon fiber reinforcement filler materials are interpositioned in the gap (G).

FIG. 7 a graphical representation of example data representing the behavior of a receiving coil member (220) configured into an inductive charge transfer system (200) as the spacing distance from the transmitting coil was increased and a carbon fiber felt was inserted into the gaps. The findings indicate that a high level of performance may be achieved over a range of gaps (G) that range from 0 to about 25 mm even when a layer of carbon fiber felt is interpositioned in the gap.

The various forms of carbon fibers and configurations, i.e. single tow, multiple tows, and felt/fabric were chosen due to their high thermal conductivity and for their capability to serve not only as a reinforcing filler to improve the strength of the advanced composite but also to function as a heat conduit to move heat in any manner that may be required.

### NON-LIMITING EMBODIMENTS

Embodiment 1 is an integrated system armament capable of receiving an inductive charge, the integrated system armament comprising at least one induction energy receiving unit and at least one electrical conductor; wherein the at least one electrical conductor is of an advanced composite material with the advanced composite material having an electrical power management region, an electrical power management sub-region, an advanced composite material forming an electrical power management micro domain, or combinations thereof; and further wherein at least one of the advanced composite material forming electrical conductor(s) further comprises a thermal power management component having a thermal power management region, a thermal power management sub-region, a thermal power management micro domain, or combinations thereof; which in combination provides the integrated system armament.

Embodiment 2 is the integrated system armament of embodiment 1 further comprising a housing for the induction energy receiving unit comprising an advanced composite material.

Embodiment 3 is the integrated system armament of embodiment 1 further comprising at least one accessory.

Embodiment 4 is the integrated system armament of embodiment 3 further comprising the at least one induction energy receiving unit affixed or integral to the integrated system armament with the induction energy receiving unit is affixed or integral to an armament component, affixed or integral within an armament component, affixed or integral to an accessory, affixed or integral within an accessory or combinations thereof.

Embodiment 5 is the integrated system armament of embodiment 4 further comprising the induction energy receiving unit comprising at least one induction member comprising of an advanced composite material.

Embodiment 6 is the integrated system armament of embodiment 1 further comprising at least one accessibly embedded contact surface.

Embodiment 7 is the integrated system armament of embodiment 6 further comprising the at least one induction member in an orientation that is planar to an external surface, non-planar to an external surface, or combinations thereof.

Embodiment 8 is the integrated system armament of embodiment 6 further comprising at least one power storage device residing within the integrated system armament.

Embodiment 9 is the integrated system armament of embodiment 3 further comprising the at least one accessory comprising an advanced composite material and where the at least one accessory is a rail, a rack (not shown), an accessory attachment device or combinations thereof.

Embodiment 10 is the integrated system armament of embodiment 3, wherein the at least one accessory comprises an armament and which in combination provides the integrated armament system.

Embodiment 11 is the integrated system armament of embodiment 6 wherein the integrated system armament is fluid tight.

Embodiment 12 is the integrated system armament of embodiment 9 further comprising an advanced composite structure.

Embodiment 13 is the integrated system armament of embodiment 10 wherein the integrated system armament comprises an advanced composite structure.

Embodiment 14 is a method of wirelessly charging an integrated system armament capable of receiving an inductive charge, the method comprising: having at least one integrated system armament capable of receiving an inductive charge and providing a source of inductive power; bringing the integrated system armament and the source of inductive power into proximity with each other such that the inductive power flows from the source of inductive power to the integrated system armament; and managing thermal energy for the integrated system armament.

Embodiment 15 is any one of embodiments 1-14 combined with any one or more embodiments 2-14.

What is claimed is:

1. An integrated system armament capable of receiving an inductive charge, the integrated system armament comprising:
at least one induction energy receiving unit, and
at least one electrical conductor;
wherein the at least one electrical conductor consists of an advanced composite material selected from the group consisting of an advanced composite material forming an electrical power management region, an advanced composite material forming an electrical power management sub-region, an advanced composite material forming an electrical power management micro domain and combinations thereof;
and further wherein at least one of the advanced composite material forming electrical conductor(s) further comprises a thermal power management component selected from the group consisting of a thermal power management region, a thermal power management sub-region, a thermal power management micro domain and combinations thereof,
which in combination provides the integrated system armament.

2. The integrated system armament of claim 1,
wherein a housing for the induction energy receiving unit comprises an advanced composite material.

3. The integrated system armament of claim 1,
wherein the integrated system armament further comprises at least one accessory.

4. The integrated system armament of claim 3,
wherein the at least one induction energy receiving unit is affixed or integral to the integrated system armament at a location selected from the group consisting of being affixed or integral to an armament component, being affixed or integral within an armament component, being affixed or integral to an accessory, being affixed or integral within an accessory and combinations thereof.

5. The integrated system armament of claim 4,
wherein the induction energy receiving unit comprises at least one induction member comprising of an advanced composite material.

6. The integrated system armament of claim 1,
further comprising at least one accessibly embedded contact surface.

7. The integrated system armament of claim 6,
wherein the at least one induction member is in an orientation to an external surface, the orientation being selected from the group consisting of a planar orientation, a non-planar orientation, and combinations thereof.

8. The integrated system armament of claim 6,
further comprising at least one power storage device residing within the integrated system armament.

9. The integrated system armament of claim 3,
wherein the at least one accessory comprises an advanced composite material and the at least one accessory is selected from the group consisting of a rail, a rack (not shown), an accessory attachment device and combinations thereof.

10. The integrated system armament of claim 3,
wherein the at least one accessory is an integrated system armament and wherein the accessory further comprises an advanced composite material.

11. The integrated system armament of claim 6, wherein the integrated system armament is fluid tight.

12. The integrated system armament of claim 9,
wherein the integrated system armament comprises an advanced composite structure.

13. The integrated system armament of claim 10,
wherein the integrated system armament comprises an advanced composite structure.

14. A method of wirelessly charging an integrated system armament capable of receiving an inductive charge, the method comprising:
providing at least one integrated system armament capable of receiving an inductive charge, providing a source of inductive power;
bringing the integrated system armament capable of receiving an inductive charge and the source of inductive power into proximity with each other such that the inductive power flows from the source of inductive power to the integrated system armament capable of receiving an inductive charge;
providing at least one conduit for movement of electrical energy for the integrated system armament,
providing at least one conduit for movement of electrical energy within the integrated system armament,
providing at least one location for restriction of movement of electrical energy within the integrated system armament selected from the group consisting of a sub-region and micro domain,
providing at least one conduit for movement of electrical energy for at least one accessory, providing at least one conduit for movement of thermal energy for the integrated system armament, providing at least one conduit for movement of thermal energy for the at least one accessory, and
providing at least one location for restriction of movement of thermal energy within the integrated system armament selected from the group consisting of a sub-region and micro domain.
